(19) United States
(12) Patent Application Publication
(10) Pub. No.: US 2005/0023314 A1
(43) Pub. Date: Feb. 3, 2005

(54) TELESCOPING ROOF RACK ASSEMBLY FOR A VEHICLE HAVING A TRUCK BED

(75) Inventors: Bruce Preston Williams, Grosse Pointe Park, MI (US); Erik Klimisch, Bloomfield Hills, MI (US)

Correspondence Address: KEVIN G. MIERZWA;ARTZ & ARTZ, P.C., 28333 TELEGRAPH ROAD, SUITE 250, SOUTHFIELD, MI, 48034, US

(73) Assignee: FORD MOTOR COMPANY, Dearborn, MI (US)

(21) Appl. No.: 10/604,566

(22) Filed: Jul. 30, 2003

(51) Int. Cl. B60R 9/00; B60R 9/045; B60R 7/00

(52) U.S. Cl. 224/405; 224/320; 224/321

(57) ABSTRACT

A telescoping roof rack assembly (10) for attachment to a vehicle (12) having a truck bed (14) is provided. The rack assembly (10) includes a roof rack section (22) and a truck bed section (24). The roof rack section (22) includes a first pair of supports (26) that are fixedly attached to a roof (16) of the vehicle (12). These supports (26) are positioned substantially parallel to each other and generally along a longitudinal axis of the vehicle (12). The truck bed section (24) includes a second pair of supports (30) that are telescopically coupled to the first pair of supports (26) of the roof rack section (22). Additionally, the second pair of supports (30) have a pair of pillar members (36) extending substantially downward therefrom for slidably coupling to the sidewalls (20) that define the truck bed (14). The rack assembly (10) is moveable between a retracted position and a fully extended position.

### BACKGROUND OF INVENTION

The present invention relates generally to vehicles, and more particularly to rack assemblies for vehicles having truck beds.

Rack assemblies for securing various objects within the truck beds of vehicles are well known. Typically, these rack assemblies are aftermarket accessories that are attached to the vehicle for the purpose of transporting relatively large objects. Examples of these large objects can include lengthy ladders, panes of glass, furniture, bikes, canoes, or a variety of other objects.

An adjustable rack assembly for accommodating objects of different lengths is disclosed in U.S. Pat. No. 5,192,107. The “107 patent discloses a multi-sectioned frame assembly having a front section and a rear section. Each section comprises a pair of opposing frame units extending substantially upward from the sidewalls of the truck bed, as well as a plurality of cross members connecting the opposing frame units. The front section is fixedly attached to a front portion of the sidewalls that define the truck bed. The rear section is telescopically fitted within the front section. In this regard, the rear section can be fully retracted within the front section, can be fully extended therefrom toward the rear of the truck bed, or otherwise placed in a position therebetween. In this respect, the rack assembly may allow objects with various lengths to be attached to the vehicle.

A drawback of this rack assembly is that the cross members may be fixed to the frame units at a height which prevents relatively tall objects from being placed in the truck bed. Moreover, even when the rack assembly is in a fully retracted position, the rack assembly still occupies a substantial portion of the truck bed. Therefore, a substantial portion of the truck bed can still remain inaccessible to relatively tall objects, even with the rack in a fully retracted position.

Therefore, it would be desirable to provide an adjustable rack assembly that allows objects of various heights, widths, and lengths to be placed in and secured within the entire truck bed of a vehicle regardless of the position of the rack.

### SUMMARY OF INVENTION

The present invention provides a telescoping roof rack assembly for attachment to a vehicle having a truck bed. In one embodiment, the telescoping roof rack assembly is comprised of a roof rack section and a truck bed section. The roof rack section includes a first pair of supports that are fixedly attached to a roof of the vehicle. These supports are positioned substantially parallel to each other and generally along a longitudinal axis of the vehicle. The truck bed section includes a second pair of supports that are telescopically coupled to the first pair of supports of the roof rack section. Additionally, the second pair of supports have a pair of pillar members extending substantially downward therefrom for slidably coupling to the sidewalls that define the truck bed.

The telescoping roof rack assembly is moveable between a retracted position and a fully extended position. In the retracted position, the first pair of supports substantially overlaps the second pair of supports. As a result, the truck bed section allows for unobstructed use of the truck bed while still permitting an object to be mounted to the roof rack section of the rack assembly. In the extended position, the truck bed section is extended substantially across the length of the truck bed thereby allowing a lengthy object to be mounted to both the roof rack section and the truck bed section.

One advantage of the present invention is that a telescoping roof rack assembly is provided that allows for unobstructed use of a truck bed of a vehicle when the rack assembly is in a fully retracted position.

Another advantage of the present invention is that a telescoping roof rack assembly is provided that allows for a variety of different shaped and different sized objects to be mounted to a vehicle, even with the roof rack in a fully retracted position.

Yet another advantage of the present invention is that a telescoping roof rack assembly is provided that can enclose tall objects within the truck bed under a protective arched covering.

Other advantages of the present invention will become apparent when viewed in light of the detailed description of the preferred embodiment when taken in conjunction with the attached drawings and appended claims.

### BRIEF DESCRIPTION OF DRAWINGS

FIG. 1 is a perspective view of a telescoping roof rack assembly in a fully extended position and integrated within a vehicle having a truck bed, in accordance with one embodiment of the present invention.

FIG. 2A is a side view of a telescoping roof rack assembly in a fully retracted position and integrated within a vehicle having a truck bed, in accordance with one embodiment of the present invention.

FIG. 2B is a side view of a telescoping roof rack assembly in a fully extended position and integrated within a vehicle having a truck bed, in accordance with one embodiment of the present invention.

FIG. 2C is a side view of a telescoping roof rack assembly in an intermediate position and integrated within a vehicle having a truck bed, in accordance with one embodiment of the present invention.

FIG. 2D is a side view of a telescoping roof rack assembly in a fully extended position with an arched cover enclosing a space within a truck bed of the vehicle, in accordance with one embodiment of the present invention.

FIG. 3A is a cross-sectional view of the telescoping roof rack assembly shown in FIG. 2A, as taken along line 3A-3A.

FIG. 3B is a partially cutaway view of the telescoping roof rack assembly shown in FIG. 1, as taken along line 3B-3B.

FIG. 3C is a partially cutaway view of a telescoping roof rack assembly in a fully retracted position, as taken along a longitudinal axis of the rack assembly.

FIG. 3D is a partially cutaway view of a telescoping roof rack assembly adapted for lengthy extension, as taken along a longitudinal axis of the rack assembly, in accordance with a another embodiment of the present invention

FIG. 4 is a partial cross-sectional view exemplifying a slidable engagement between a pillar member of a telescoping roof rack assembly and slotted rail integrated on a sidewall of a vehicle, in accordance with one embodiment of the present invention.

FIG. 5A is a partially cut away top view exemplifying a fastener coupled to a slotted rail, in accordance with one embodiment of the present invention.

FIG. 5B is a partial cross-sectional view of the fastener and slotted rail shown in FIG. 5A, as taken along line 5B-5B.

FIG. 5C is a partial cross-sectional view of the fastener and slotted rail shown in FIG. 5A, as taken along line 5C-5C.

FIG. 6A is a partially cut away top view of a fastener and a slotted rail, in accordance with another embodiment of the present invention.

FIG. 6B is a partial cross-sectional view of the fastener and the slotted rail shown in FIG. 6A, taken along line 6B-6B. and

FIG. 7 is a logic flow diagram illustrating one method for manufacturing a telescoping roof rack assembly, in accordance with one embodiment of the present invention.

### DETAILED DESCRIPTION

In the following figures, the same reference numerals are used to identify the same components in the various views.

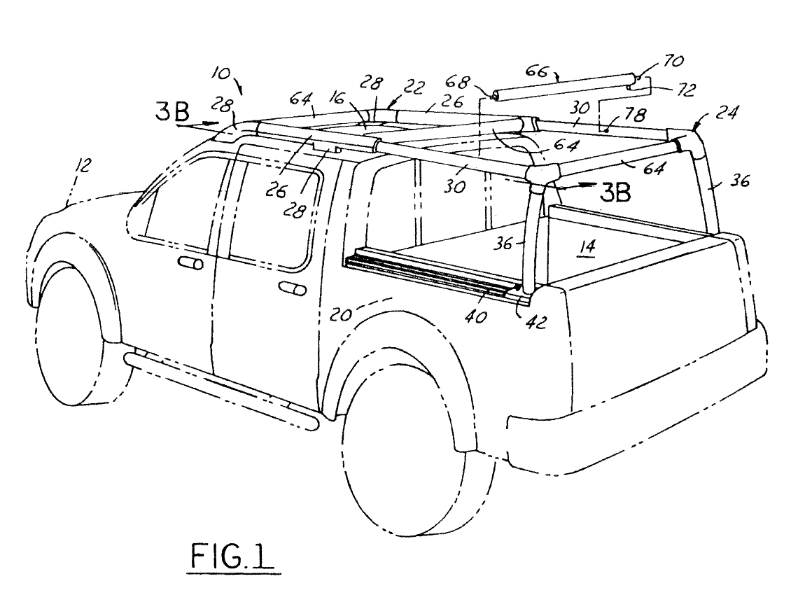

Referring to FIG. 1, there is shown a perspective view of a telescoping roof rack assembly (hereinafter referred to as “rack assembly”) 10 in a fully extended position and attached to a vehicle 12 having a truck bed 14, in accordance with one embodiment of the present invention.

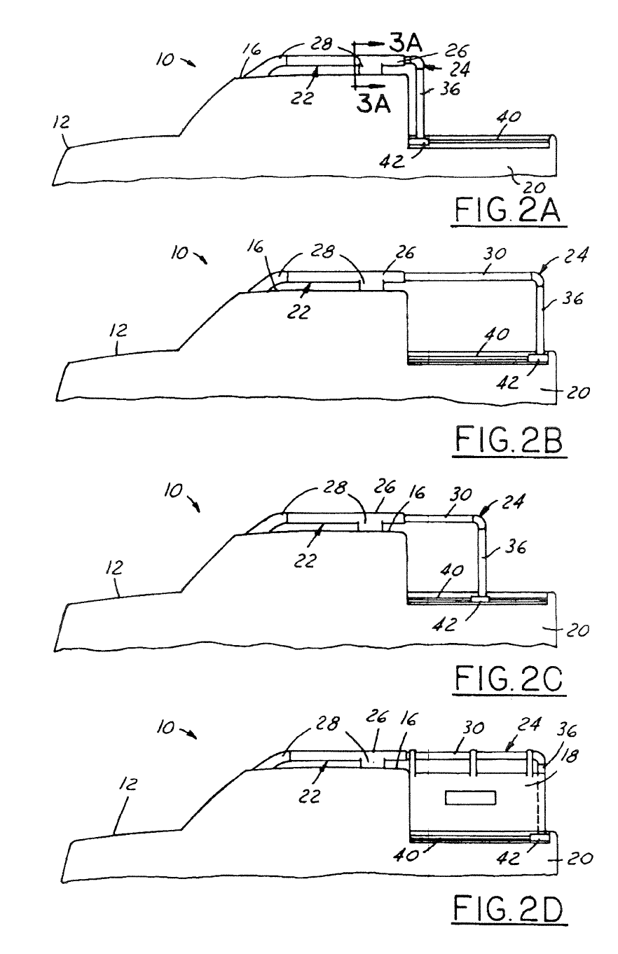

The rack assembly 10 is moveable between a fully retracted position (as shown in FIG. 2A) and a fully extended position (as shown in FIG. 2B).

Referring specifically to FIG. 2A, in the fully retracted position, the rack assembly 10 permits unobstructed use of the truck bed 14 such that objects of various shapes and sizes may be placed therein. In other words, when the rack assembly 10 is fully retracted, no part of the rack assembly 10 surrounds the truck bed 14 in a manner that can substantially impair the use of the space within, above, and around the truck bed 14. In this regard, relatively large and tall objects, such as furniture or appliances, can be easily placed in the truck bed 14 without interference from the rack assembly 10. Also, the rack assembly 10 in the retracted position may still allow for smaller-sized objects to be mounted thereto so as to secure those objects to the roof 16 of the vehicle 12.

Referring now to FIG. 2B, in the fully extended position, the rack assembly 10 extends substantially across the length of the vehicle 12 and over substantially the entire truck bed 14. This structure allows for lengthy objects to be mounted to the vehicle 12. By way of example, a canoe, a lengthy ladder, or lengthy ductwork may be secured to the top of the rack assembly 10. In addition, more objects may be placed within the space in the truck bed 14 underneath the rack assembly 10.

Referring now to FIG. 2C, the rack assembly 10 may also be placed in an intermediate position located between the fully extended position and the fully retracted position. Positioning the rack assembly 10 in this manner allows for a variety of different shaped and different sized objects to be secured to the vehicle 12. For example, moderately lengthy objects, i.e. a kayak or skis, may be secured to the top of the rack assembly 10. Additionally, a relatively tall object, i.e. a bookshelf, may be placed in a rear section of the truck bed 14 that is not covered by the rack assembly 10. Finally, smaller-sized objects may be placed in a front section of the truck bed 14 underneath the rack assembly 10. It will also be understood that these taller objects or items can be tied to the rack assembly 10 to firmly secure them within the truck bed 14.

In addition to the examples described above and illustrated in FIGS. 2A-2C, one skilled in the art will understand that the rack assembly 10 may be disposed in a variety of other positions for securing an assortment of different shaped and different sized objects to the vehicle 12.

As shown in FIG. 2D, in another embodiment of the present invention, the rack assembly 10 includes an arched cover 18 for enclosing objects within the truck bed 14. The arched cover 18 is formed in a manner that permits enclosure of objects within the truck bed 14 that are as tall as the roof 16 of the vehicle 12. The cover 18 can be secured to the sidewalls 20 of the truck bed 14, as well as to the rack assembly 10.

In one embodiment, the arched cover 18 is a soft panel collapsible top. The top includes a front end portion that is secured to the rear upper portion and side portions of the truck cab. This engagement may be accomplished by button fasteners, toothed fasteners, or other suitable fasteners as desired. The rear end portion of the top is attached to the rack assembly 10 by similar fasteners. Alternatively, the rear end portion of the top can include a sleeve through which a portion of the rack assembly passes. In view of this structure, the top is extendable and collapsible along with the telescoping truck bed section 24 of the rack assembly 10.

In another embodiment, the arched cover 18 is a solid panel modular top. This top is comprised of separate panels that attach to the rack assembly 10, the sidewalls 20, and the rear upper portion and side portions of the truck cab for the purpose of constructing an inverted u-shaped enclosure. In other words, the rack assembly 10 and surrounding portions of the vehicle 12 can form a space frame for mounting the panels thereon. Other configurations of the cover 18 will be readily understood by one skilled in the art. Also, fasteners similar to those described for the soft panel collapsible top can be utilized for constructing the solid panel modular top and securing it to the vehicle 12.

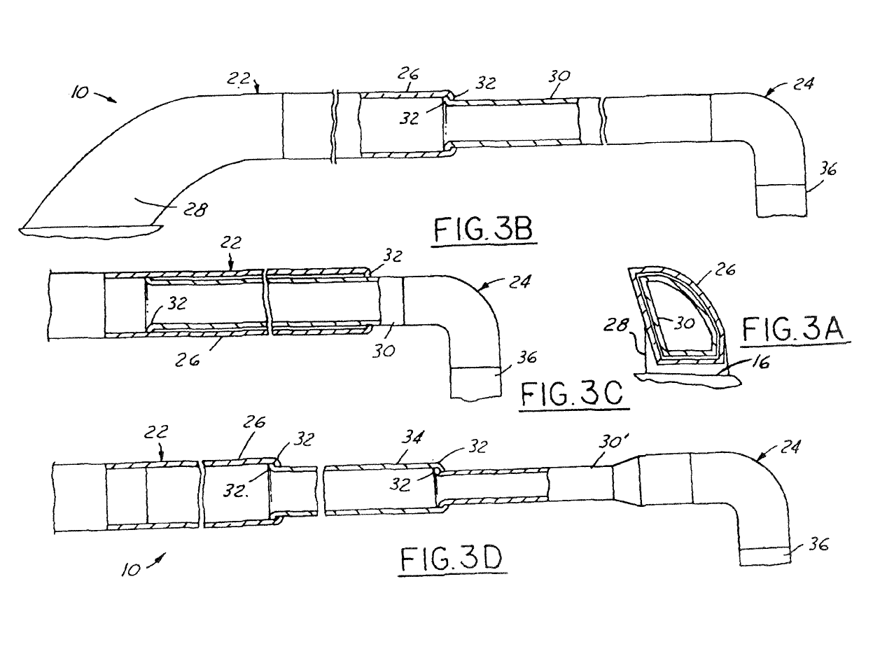

Referring now to FIGS. 3A-3C, there are shown cross-sectional views of the rack assembly 10. FIGS. 3A and 3B are cross-sectional views of the rack assembly shown in FIG. 1, as taken along lines 3A-3A and 3B-3B, respectively. FIG. 3C is a cross-sectional view of the rack assembly 10 in a fully retracted position, taken along a longitudinal axis of the rack assembly 10. These views illustrate the telescopic fitting between two major sections of the rack assembly.

Referring back to FIG. 1, the rack assembly 10 is comprised of a roof rack section 22 and a truck bed section 24 that is telescopically fitted with the roof rack section 22.

The roof rack section 22 includes a first pair of supports 26 that are positioned substantially parallel to each other along a longitudinal axis of the vehicle 12. These first supports 26 are fixedly attached to the roof 16 of the vehicle 12. In one embodiment, two or more leg portions 28 extend downwardly from each support 26 for attachment to the roof 16 of the vehicle 12. However, it is understood that the first pair of supports 26 may be attached to the roof 16 by a variety of other suitable methods. Moreover, one or more cross members 64 extend between each of the first supports 26. These cross members 64 are intended to provide support for objects secured thereto.

The truck bed section 24 of the rack assembly 10 includes a second pair of supports 30 that are telescopically coupled to the first pair of supports 26. As shown in the embodiment illustrated in the FIGS. 3A-3C, the second pair of supports 30 are sized for insertion into the first pair of supports 26. As best shown in FIG. 3B, the supports have opposing detent flanges 32 for preventing the second pair of supports 30 from being completely extracted from the first pair of supports 26. One skilled in the art will understand that a variety of other suitable detent couplings or anti-separation mechanisms may provide for a telescopic fitting between the two pairs of supports 26, 30. Also, it is understood that the second pair of supports 30 may be sized for receiving the first pair of supports 26 rather than for insertion into the first pair of supports 26.

In an alternative embodiment, as shown in FIG. 3D, the truck bed section 24 includes an intermediate pair of supports 34 telescopically fitted between the first pair of supports 26 and a second pair of supports 30″. The intermediate pair of supports 34 is intended to permit the truck bed section 24 to extend a greater distance toward the rear of the vehicle 12. In this regard, this construction is similar to that of a telescoping antenna whereby supports with decreasingly sized diameters extend from a base support.

Moreover, one or more supplemental cross members 64 may be secured across the second pair of supports 30 (as shown in FIG. 1), the intermediate pair of supports 34, or both pairs of supports if desired. These supplemental cross members 64 can provide additional support for lengthy objects placed across the rack assembly 10 when the rack assembly 10 is moved to an extended position. A variety of fasteners may be utilized to attach the supplemental cross member 64 to the supports 30, 34. For example, the second pair of supports 30 may have a pair of holes 78 integrally formed within their interior sides. One of the holes 78 may be intended to receive a fixed nub 68 extending from one end of the supplemental cross member 64 while the other hole 64 may be intended to receive a spring loaded nub 70 from the opposing end of the supplemental cross member 64. This spring loaded nub 70 may also have a retractor arm 72 extending therefrom for allowing a user to retract the spring loaded nub 70 from within the hole 78 of the second support 30 so as to detach the supplemental cross member 64 from the rack assembly 10.

Referring back to FIGS. 2A-2C, each of the second pair of supports 30 has one or more substantially upright pillar members 36 downwardly extending therefrom. These pillar members 36 are intended to support the rack assembly 10 when objects are secured to the top of the rack assembly 10. Additionally, the pillar members 36 can be utilized for securing ropes, cords, or other fasteners thereto. Although the figures illustrate only one pillar member extending from the absolute rear of the support, it is understood that other constructions can be employed. For example, substitute or additional pillar members may be coupled to a middle section of the second pair of supports 30.

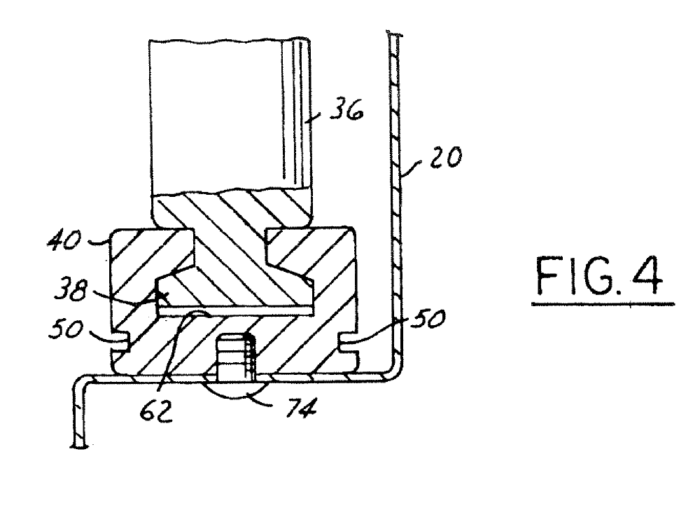

Referring now to FIG. 4, there is shown a partial cross-sectional view of a slidable engagement between a bottom portion of a pillar member 36 and one of the sidewalls 20 defining the truck bed 14 of the vehicle 12, in accordance with one embodiment of the present invention. Specifically, the bottom portion of the pillar member 36 has a tongue portion 38 for engaging a groove 62 formed within a slotted rail 40. The slotted rails 40 are attached to the sidewalls 20 by way of screws 74, bolts, rivets, or other suitable fasteners as desired. These rails 40 are intended to slidably attach the truck bed section 24 to the sidewalls 20 of the vehicle 12. This tongue-in-grove engagement works in conjunction with the telescopic fitting between the truck bed section 24 and the roof rack section 22 so as to permit the truck bed section 24 to slide between the fully extended position and the fully retracted position. However, it is understood that a variety of other suitable fasteners may be utilized for providing the slidable engagement between the pillar member 36 and the sidewall 20.

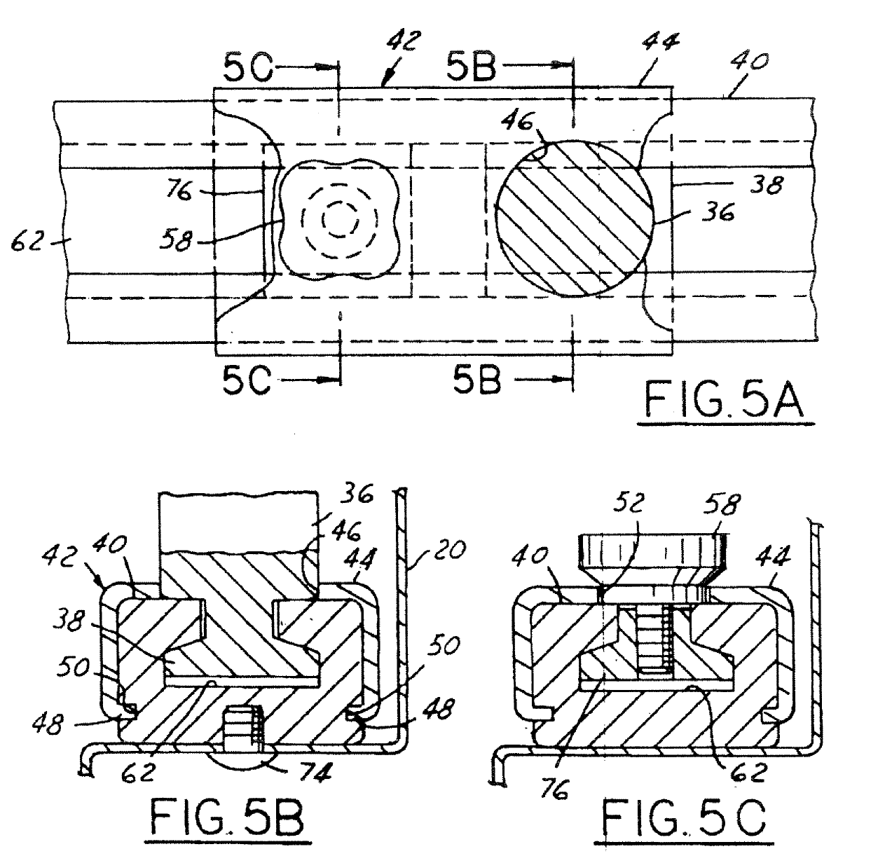

Referring now to FIGS. 5A-5C, there is illustrated a fastener 42 coupled to the slotted rail 40 of the sidewall 20, according to one embodiment of the present invention. The fastener 42 is intended to secure the pillar member 36 in a desired position on the sidewall 20. Specifically, the fasteners 42 prevent movement of the truck bed section 24 along the longitudinal axis of the vehicle 12.

The fastener 42 includes a bracket 44 that is coupled to the pillar member 36 and is moveable along the length of the rail 40. The bracket 44 has a central opening 46 for surrounding the pillar member 36 and allowing the fastener 42 to secure the truck bed section 24 in a desired position. The bracket 44 also includes a pair of flanges 48 for securing the bracket 44 to the rail 40. These flanges 48 are intended to slide within respective channels 50 formed within the rail 40 thereby allowing movement of the rack assembly 10 between retracted and extended positions.

As best shown in FIG. 5C, the bracket 44 includes one or more holes 52 for receiving a bolt member 54 or the equivalent thereof. In one embodiment, the bolt member 54 has a shaft 56 with external threading formed thereon for engaging internal threading of a nut member 76 that is disposed within the groove 62 of the slotted rail 40. In an alternative embodiment, the bolt member 54 may be secured to the rail 40 by a spring loaded mechanism located on an internal portion of the rail 40. The spring loaded mechanism may be positioned between the bracket 44 and a portion of the bolt member 54 in order to bias the bolt member 54 downward and into the slotted rail 40. However, the bolt member 54 may be secured to the rail 40 by a variety of other suitable mechanisms or constructions.

The bolt member 54 also has a knob 58 integrated thereon for permitting a user to twist the bolt member 54 so as to tighten the engagement between the bolt member 54 and the nut member 76. This engagement creates a friction fitting between the fastener 42 and the rail 40. As a result, the fastener 42 is secured to the rail 40 in a desired position and the rack assembly 10 is selectively fixed in the desired extended or retracted position.

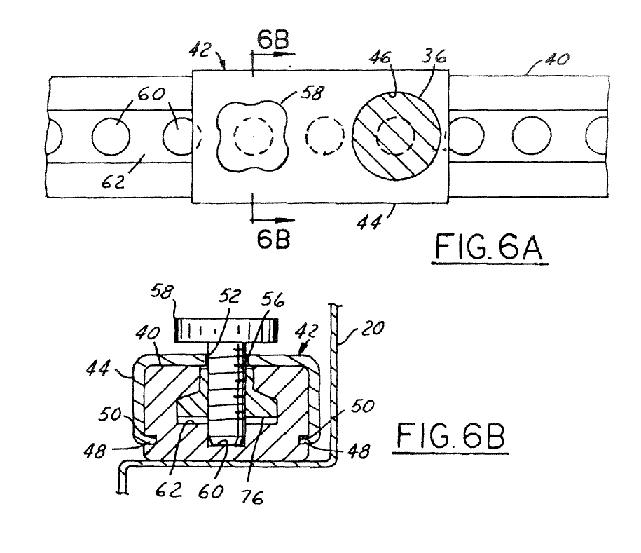

In an alternative embodiment, as shown in FIGS. 6A and 6B, the rail 40 may have a series of notches 60 formed therein for receiving an end portion of the shaft 56 so as to secure the fastener 42 in a desired position on the rail 40.

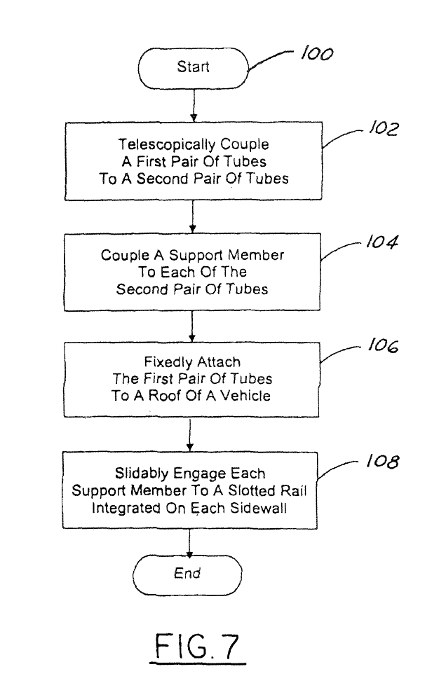

Referring now to FIG. 7, there is shown a logic flow diagram depicting a method for manufacturing a rack assembly 10 for a vehicle 12 having a truck bed 14, in accordance with one embodiment of the invention. The method commences in step 100 and immediately proceeds to step 102.

In step 102, a second pair of supports 30 is inserted into a first pair of supports 26 that are sized to receive the second pair of supports 30. In one embodiment, each of the second pair of supports 30 passes through one of the first pair of supports 26 until opposing flanges 48 integrated on each of supports are engaged to each other. This coupling provides for the telescopic fitting detailed above. Then, the sequence proceeds to step 104.

In step 104, a pillar member 36 is coupled to each of the second pair of supports 30. A variety of fasteners may be utilized to accomplish this step. For example, a welding attachment, a series of bolt fasteners, or rivet fasteners may be employed. Then the sequence proceeds to step 106.

In step 106, the first pair of supports 26 is fixedly attached to the roof 16 of the vehicle 12. Each support 26 has two or more leg portions 28 extending therefrom for attachment to the roof 16. The supports 26 are placed substantially parallel to each other on opposing sides of a longitudinal axis of the vehicle 12. Alternatively, other suitable positions may be utilized as desired. Once the supports 26 are positioned in the desired location, the leg portions 28 are fixedly attached to the roof 16 by bolts, rivets, or any other suitable fastener. Then, the sequence immediately proceeds to step 108.

In step 108, a bottom portion of each pillar member is slidably engaged to a slotted rail 40 integrated on one of the sidewalls 20 lining the truck bed 14. This step may be accomplished by a tongue-in-groove engagement between the pillar member 36 and the rail 40. For example, the tongue portion 38 may be inserted into the groove 62 at the rear portion of the rail 40. Moreover, a fastener 42, as described above, may be coupled to the slotted rail 40 and placed adjacent to the pillar member 36 for securing the rack assembly 10 in a desired position. However, it is understood that a variety of other slidable engagements may be employed.

While particular embodiments of the invention have been shown and described, numerous variations and alternate embodiments will occur to those skilled in the art. Accordingly, it is intended that the invention be limited only in terms of the appended claims.

1. A telescoping roof rack assembly for a vehicle having a truck bed, comprising:
a roof rack section for attachment to a roof of the vehicle, said roof rack section including a first pair of supports fixedly coupled to said roof of the vehicle, said first pair of supports being positioned substantially parallel to each other and generally along a longitudinal axis of the vehicle; and
a truck bed section including a second pair of supports that are telescopically coupled to said first pair of supports of said roof rack section, said truck bed section further including a pair of pillar members extending substantially downwardly from said second pair of supports, each of said pillar members having a bottom portion slidably coupled to a sidewall of the truck bed;
wherein the telescoping roof rack assembly is moveable between a retracted position and an extended position, the telescoping roof rack assembly in said retracted position permitting attachment of an object to said roof rack section and unobstructed use of the truck bed, the telescoping roof rack assembly in said extended position extending over the truck bed and permitting attachment of said object to at least one of said roof rack section and said truck bed section.

2. The telescoping roof rack assembly of claim 1 wherein said roof rack section further includes a plurality of leg portions extending from each of said first pair of supports for attaching said roof rack section to said roof.

3. The telescoping roof rack assembly of claim 2 wherein each of said first pair of supports is sized for telescopingly receiving one of said second pair of supports.

4. The telescoping roof rack assembly of claim 1 wherein said first pair of supports has at least one cross member extending therebetween.

5. The telescoping roof rack assembly of claim 1 wherein said second pair of supports has at least one cross member extending therebetween.

6. The telescoping roof rack assembly of claim 1 further comprising:
an intermediate pair of supports that are telescopically fitted between said first pair of supports and said second pair of supports, said intermediate pair of supports for increasing extension of the telescoping roof rack assembly.

7. The telescoping roof rack assembly of claim 6 wherein each of said first pair of supports is sized for telescopingly receiving one of said intermediate pair of supports, each of said intermediate pair of supports being sized for telescopically receiving one of said second pair of supports.

8. The telescoping roof rack assembly of claim 7 further comprising:
at least one supplemental cross member for attachment between at least one of said second pair of supports and said intermediate pair of supports.

9. The telescoping roof rack assembly of claim 1 wherein said bottom portion of each of said pair of pillar members includes a tongue protrusion for engaging a slotted rail formed within said sidewall.

10. A telescoping roof rack assembly for a vehicle having a truck bed, comprising:
a roof rack section for attachment to a roof of the vehicle, said roof rack section including a first pair of supports fixedly coupled to said roof of the vehicle, said first pair of supports being positioned substantially parallel to each other and along a longitudinal axis of the vehicle;
a truck bed section including a second pair of supports that are telescopically coupled to said first pair of supports of said roof rack section, said truck bed section further including a pair of pillar members extending substantially downwardly from said second pair of supports, each of said pillar members having a bottom portion slidably coupled to one of a pair of sidewalls lining the truck bed; and
an arched cover for enclosing a space within the truck bed, said arched cover defining said space at a height substantially equal to a height of said roof, said arched cover adapted for attachment to at least one of said sidewalls lining the truck bed and said truck bed section of the telescoping roof rack assembly;
wherein the telescoping roof rack assembly is moveable between a retracted position and an extended position, the telescoping roof rack assembly in said retracted position permitting attachment of an object to said roof rack section and unobstructed use of the truck bed, the telescoping roof rack assembly in said extended position extending over the truck bed and permitting attachment of said object to at least one of said roof rack section and said truck bed section.

11. The telescoping roof rack assembly of claim 10 wherein said roof rack section further includes a plurality of leg portions extending from each of said first pair of supports for attaching said roof rack section to said roof.

12. The telescoping roof rack assembly of claim 11 wherein each of said first pair of supports is sized for telescopingly receiving one of said second pair of supports.

13. The telescoping roof rack assembly of claim 10 wherein said first pair of supports has at least one cross member extending therebetween.

14. The telescoping roof rack assembly of claim 10 wherein said second pair of supports has at least one cross member extending therebetween.

15. The telescoping roof rack assembly of claim 10 further comprising:
an intermediate pair of supports that are telescopically fitted between said first pair of supports and said second pair of supports, said intermediate pair of supports for increasing extension of the telescoping roof rack assembly.

16. The telescoping roof rack assembly of claim 15 wherein each of said first pair of supports is sized for telescopingly receiving one of said intermediate pair of supports, each of said intermediate pair of supports being sized for telescopically receiving one of said second pair of supports.

17. The telescoping roof rack assembly of claim 16 further comprising:
at least one supplemental cross member for attachment between at least one of said second pair of supports and said intermediate pair of supports.

18. A method for manufacturing a telescoping roof rack assembly for a vehicle having a truck bed, comprising:
fixedly coupling a first pair of supports to a roof of the vehicle, said first pair of supports positioned substantially parallel to each other along a longitudinal axis of the vehicle;
telescopically coupling a second pair of supports to said first pair of supports, said second pair of supports being moveable between a retracted position and an extended position, said second pair of supports in said retracted position overlapping said first pair of supports and permitting unobstructed use of the truck bed, said second pair of supports in said extended position extending over the truck bed; and
slidably coupling a pair of pillar members to a pair of sidewalls lining the truck bed.

19. The method of claim 18 wherein telescopically coupling said second pair of supports to said first pair of supports comprises inserting said second pair of supports into said first pair of supports, respectively.

20. The method of claim 19 wherein slidably coupling said pair of pillar members to said pair of sidewalls comprises coupling a tongue portion of each of said pillar members to a channel integrate in each of said sidewalls.
